(19) United States
(12) Patent Application Publication
(10) Pub. No.: US 2012/0105943 A1
(43) Pub. Date: May 3, 2012

(54) Laser ray wavelength modification apparatus

(75) Inventor: Hidekazu Hatanaka, Hyogo (JP)

(73) Assignee: USHIO DENKI KABUSHIKI KAISHA, Tokyo (JP)

(21) Appl. No.: 13/317,936

(22) Filed: Nov. 1, 2011

(30) Foreign Application Priority Data
Nov. 2, 2010 (JP) 2010-245860

(51) Int. Cl. G02F 1/35

(52) U.S. Cl. 359/326

(57) ABSTRACT

A laser ray wavelength modification apparatus that includes a semiconductor laser element, a fundamental wave light reflecting element, a wavelength modification element, a selective reflection member and a dichroic mirror. The selective reflection member permits fundamental wave light among light rays emitted from the wavelength modification element to pass through to the fundamental wave light reflecting element while reflecting the wavelength modification light. The dichroic mirror is arranged between the semiconductor laser element and the wavelength modification element. The dichroic mirror transmits the fundamental wave light and removes by reflection out the wavelength modification light.

### CROSS-REFERENCES TO RELATED APPLICATION

This application claims priority from Japanese Patent Application Serial No. 2010-245860 filed Nov. 2, 2010, the contents of which are incorporated herein by reference in their entirety.

### TECHNICAL FIELD

The present invention relates to a laser ray wavelength modification apparatus that converts the wavelength of laser rays, using a nonlinear optical crystal, and more specifically relates to a laser ray wavelength modification apparatus that uses a VBG (volume Bragg grating) as a reflective element and that uses a periodic polarization inversion type lithium niobate (PPLN: Periodically Poled Lithium Niobate) as the nonlinear optical crystal.

### BACKGROUND

An apparatus may convert or modify the wavelengths of a laser ray, emitted from a semiconductor laser element by a nonlinear optical crystal, into a desired wave length, for example, the wavelength of second harmonic wave. In such a wavelength modification apparatus, higher light extraction efficiency of wavelength modification light and a higher power optical output is desired.

Specifically, high stability of oscillation wavelength with respect to a temperature change is demanded to realize a high power optical output. Thus, a laser ray wavelength modification apparatus where a reflective element operating as an external resonator to a semiconductor laser element may be provided, to maintain the high stability of oscillation wavelength and to realize miniaturization of such an apparatus. Further, a nonlinear optical crystal may be arranged between the semiconductor laser element and the reflective element.

FIG. 2 is a schematic diagram of an example of a structure of a laser ray wavelength modification apparatus. This laser ray wavelength modification apparatus comprises a semiconductor laser element 12, which is provided on a substrate 11 and which emits laser rays as fundamental wave light; a fundamental wave light reflecting element 14, which is made up of a volume Bragg grating (VBG) which operates as an external resonator with respect to this semiconductor laser element 12; a wavelength converting element 13, which is arranged between the semiconductor laser element 12 and the fundamental wave light reflecting element 14 that converts a wavelength portion of fundamental wave light to form wavelength modification light; a dichroic mirror 15, which is arranged between the semiconductor laser element 12 and the wavelength converting element 13 that transmits the fundamental wave light and that reflects out the wavelength modification light; and a reflective mirror 16, which reflects the wavelength modification light reflected by this dichroic mirror 15 to the outside.

In this laser ray wavelength modification apparatus, since the fundamental wave light (λa) emitted from the semiconductor laser element 12 passes through the dichroic mirror 15 and then passes through the wavelength modification element 13, the wavelength portion of the fundamental wave light (λa) is converted to form wavelength modification light (λab). And among light rays, which are emitted from the wavelength modification element 13 and directed to the fundamental wave light reflecting element 14, the wavelength modification light (λab) passes through the fundamental wave light reflecting element 14 and is outputted to the outside. On the other hand, when the fundamental wave light (λa2), whose wavelength has not been converted, is reflected by the fundamental wave light reflecting element 14 and passes through the wavelength modification element 13 again, part of the fundamental wave light (λa2), whose wavelength is converted, turns into wavelength modification light (λa2b). And among the light rays, which are emitted from the wavelength modification element 13 and directed to the semiconductor laser element 12, the wavelength modification light (λa2b) is reflected by the dichroic mirror 15 and the reflective mirror 16 and is outputted to the outside. On the other hand, the fundamental wave light (λa3), whose wavelength has not been converted, passes through the dichroic mirror 15, is directed to the semiconductor laser element 12, and is amplified inside the semiconductor laser element 12 again.

Further, when the fundamental wave light (λa) emitted from the semiconductor laser element 12 repeats reflection and amplification between the semiconductor laser element 12 and the fundamental wave light reflecting element 14, part of the fundamental wave light (λa), whose wavelength is converted by the wavelength modification element 13, turns into the wavelength modification light (λab and λa2b . . . ) and is sequentially outputted to the outside.

However, in such a laser ray wavelength modification apparatus, among the wavelength modification lights (λab and λa2b) outputted to the outside, part of the wavelength modification light (λab) that passes through the fundamental wave light reflecting element 14, is also absorbed by the fundamental wave light reflecting element 14, so that it becomes difficult to secure a high light extraction efficiency of the wavelength modification light. Thus, high power optical output is not sufficiently achieved.

Specifically, where the fundamental wave light (λa) emitted from the semiconductor laser element 12 is infrared light whose wavelength is, for example, 1064 nm, the transmittance of the fundamental wave light reflecting element 14 with respect to the wavelength modification light (λab), which is obtained by converting the wavelength by the wavelength modification element 13, is 68.9%. That is, one third of the wavelength modification light (λab), which enters the fundamental wave light reflecting element 14, is absorbed by the fundamental wave light reflecting element 14. Moreover, where the fundamental wave light (λa) emitted from the semiconductor laser element 12 is infrared light whose wavelength is, for example, 930 nm, the transmittance of the fundamental wave light reflecting element 14 with respect to the wavelength modification light (λab), which is obtained by converting the wavelength by the wavelength modification element 13, is 51.8%. That is, about a half of the wavelength modification light (λab) that enters the fundamental wave light reflecting element 14 is absorbed by the fundamental wave light reflecting element 14. Here, this transmittance is a value where the thickness of the fundamental wave light reflecting element 14 is 4 mm.

Thus, in addition to the problem of absorption due to such a fundamental wave light reflecting element (VBG), there is also a problem that the light, which enters the fundamental wave light reflecting element (VBG), is reflected. To solve such problems, a method of forming AR (Anti-Reflection) coating on a reflective face of the fundamental wave light reflecting element (VBG) is proposed (refer to Japanese Patent Application Publication No. 2008-282883).

### SUMMARY

Thus, an object of the below described is to offer a laser ray wavelength modification apparatus capable of outputting light having desired wavelength at high light extraction efficiency.

A laser ray wavelength modification apparatus that contains a semiconductor laser element that emits a laser ray as a fundamental wave light; a fundamental wave light reflecting element having a volume Bragg grating (VBG) operating as an external resonator with respect to the semiconductor laser element; a wavelength modification element arranged between the semiconductor laser element and the fundamental wave light reflecting element that converts a wavelength portion of the fundamental wave light to a wavelength modification light; a selective reflection member that transmits and directs the fundamental wave light to the fundamental wave light reflecting element and that reflects the wavelength modification light from among emission of the wavelength modification element; and a dichroic mirror arranged between the semiconductor laser element and the wavelength modification element that transmits the fundamental wave light and reflects the wavelength modification light.

Further, the wavelength modification element may comprise of a Periodically Poled Lithium Niobate (PPLN) and the dichroic mirror may incline with respect to the optical axis of the fundamental wave light reflecting element.

### BRIEF DESCRIPTION OF THE DRAWINGS

Other features and advantages of the present laser ray wavelength modification apparatus will be apparent from the ensuing description, taken in conjunction with the accompanying drawings, in which:

FIG. 1 is a schematic view of an example of a structure of a laser ray wavelength modification apparatus; and

FIG. 2 is a schematic view of an example of a structure of a laser ray wavelength modification apparatus.

### DESCRIPTION

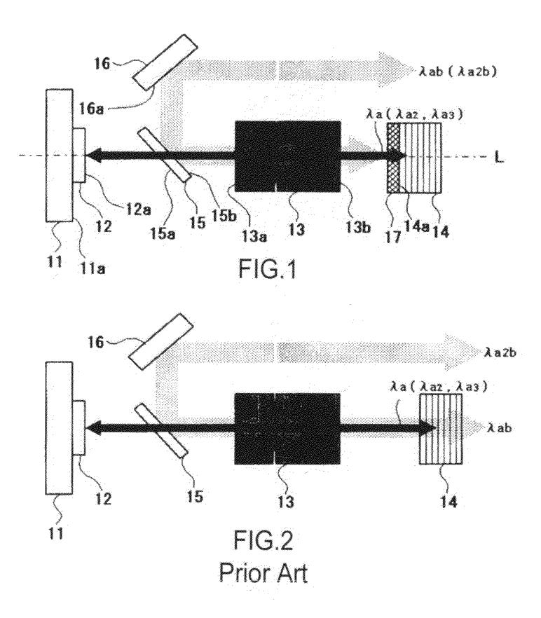

FIG. 1 is a schematic view of an example of the structure of a laser ray wavelength modification apparatus. This laser ray wavelength modification apparatus, which converts the wavelength of laser light emitted from a semiconductor laser element into desired wavelength (for example, the wavelength of second harmonics) comprises a chip shape semiconductor laser element 12 provided on a substrate 11 that emits laser rays as fundamental wave light; a fundamental wave light reflecting element 14 is arranged to face an optical radiation face 12a of the semiconductor laser element 12 on a front side of the semiconductor laser element 12 in a laser ray radiation direction; a wavelength modification element 13 arranged between the semiconductor laser element 12 and the fundamental wave light reflecting element 14, on the optical axis L of the fundamental wave light reflecting element 14 (for example, the optical axis that extends in a direction perpendicular to the optical radiation face 12a of the semiconductor laser element 12); and a plate-like dichroic mirror 15 arranged between the semiconductor laser element 12 and the wavelength modification element 13 that is inclined with respect to the optical axis L.

In this example, two or more semiconductor laser element components 12 are arranged on the substrate 11 so that the semiconductor laser element components 12 may be aligned in a direction perpendicular to a paper sheet showing FIG. 1, and form a surface light emission type (vertical cavity surface emitting laser) array, from which laser rays are emitted, due to resonance, in a direction perpendicular to a substrate face 11a where the semiconductor laser elements are arranged. In addition, an end surface light emission type array, by which laser rays are resonated in parallel to the substrate 11 so that emission is produced, can also be used. The fundamental wave light emitted from the semiconductor laser element 12 may be, for example, infrared light having wavelength of 1064 nm, infrared light having wavelength of 976 nm, or infrared light having wavelength of 930 nm, etc.

The wavelength modification element 13 is a nonlinear optical crystal, which converts part of the fundamental wave light emitted from the semiconductor laser element 12, and such a nonlinear optical crystal is preferably a Periodically Poled Lithium Niobate (PPLN).

The fundamental wave light reflecting element 14 consists of a volume Bragg grating (VBG), which operates as an external resonator with respect to the semiconductor laser element 12. This volume Bragg grating (VBG) is formed by alternatively arranging low refractive-index material and high refractive-index material, so that it has the wavelength selection characteristics of reflecting light in a specific wavelength range. This fundamental wave light reflecting element 14 preferably has a thickness of, for example, 3-6 mm.

A selective reflection member 17 is provided on a side of a face 14a of the fundamental wave light reflecting element 14, which faces the semiconductor laser element 12, where the selective reflection member 17 transmits fundamental wave light among light rays which are emitted from the wavelength modification element 13 and travel toward the fundamental wave light reflecting element 14, and which reflects wavelength modification light.

This selective reflection member 17 is preferably formed of a lamination body that is a multilayer film made up of, for example, silica (SiO₂) layers and titania (TiO₂) layers. For example, in the structure in which light rays different from each other in a wavelength band (for example, light rays in two bands) are used as fundamental wave light, the lamination body is preferably a multi-layer film formed by laminating 20 to 30 layers made up of SiO₂ layers and TiO₂ layers. Moreover, for example, in case of the structure in which light in a narrow wavelength band is used as fundamental wave light, 10-15 layers are preferably laminated to form such a multilayer film. The thickness of this selective reflection member 17 is preferably 1-3 micrometers (μm). Such a selective reflection member 17 may be formed by a vapor-depositing method.

This selective reflection member 17 may be integrally formed on the face 14a of the fundamental wave light reflecting element 14, or provided separately from the fundamental wave light reflecting element 14.

The dichroic mirror 15 has the wavelength selection characteristics of transmission of light in a specific wavelength range and reflection of light in the remaining wavelength range, so that the fundamental wave light passes therethrough while the wavelength modification light is reflected to be picked up. As long as this dichroic mirror 15 is arranged so that wavelength modification light may be reflected to be taken out, the arrangement is not in particular limited to the above. For example, the dichroic mirror 15 is preferably arranged so that the face 15b, that the wavelength modification light reflected from the fundamental wave light reflecting element 14 enters, is inclined by 30 to 60 degrees with respect to the optical axis L.

In this laser ray wavelength modification apparatus, for example, a reflective mirror 16, is provided so that a reflective face 16a is arranged to be perpendicular to the face 15b of the dichroic mirror 15, whereby the wavelength modification light, which is reflected from the face 15b of the dichroic mirror 15, is outputted to the outside as parallel light parallel to the optical axis L.

In such a laser ray wavelength modification apparatus, the fundamental wave light (λa) emitted from the semiconductor laser element 12 enters the face 15a of the dichroic mirror 15, passes through the dichroic mirror 15, is emitted from the face 15b of the dichroic mirror 15, and enters the face 13a of the wavelength modification element 13. When this fundamental wave light (λa) passes through the wavelength modification element 13, a wavelength portion of the fundamental wave light (λa) is converted to form wavelength modification light (λab), so that the wavelength modification light (λab) and the fundamental wave light (λa2), whose wavelength has not been converted, are emitted from the other face 13b of the wavelength modification element 13. Among the light rays (λab, λa2), which are emitted from the other face 13b of the wavelength modification element 13 and which are directed to the fundamental wave light reflecting element 14, the wavelength modification light (λab) is reflected by the selective reflection member 17, and enters the other face 13b of the wavelength modification element 13 again to pass through the wavelength modification element 13, and then is emitted from the face 13a of the wavelength modification element 13, so that the emitted light rays are reflected by the face 15b of the dichroic mirror 15 and the reflective face 16a of the reflective mirror 16, and are outputted to the outside as a parallel light parallel to the optical axis L. On the other hand, among the light rays (λab, λa2), which are emitted from the other face 13b of the wavelength modification element 13 and are directed to the fundamental wave light reflecting element 14, the fundamental wave light rays (λa2), whose wavelength has not been converted, pass through the selective reflection member 17, and are reflected by the fundamental wave light reflecting element 14. Thus these light rays pass through the selective reflection member 17 again and enter the other face 13b of the wavelength modification element 13. When this fundamental wave light (λa2) passes through the wavelength modification element 13, a wavelength portion of the fundamental wave light (λa2) is converted to form the wavelength modification light (λa2b). The wavelength modification light (λa2b) and the fundamental wave light (λa3), whose wavelength has not been converted, are emitted from the face 13a of the wavelength modification element 13. And among the light rays (λa2b, λa3), which are emitted from the face 13a of the wavelength modification element 13 and are directed to the semiconductor laser element 12, the wavelength modification light (λa2b) is reflected by the face 15b of the dichroic mirror 15 and a reflective face 16a of the reflective mirror 16, and is outputted to the outside, as parallel light parallel to the optical axis L. On the other hand, among the light rays (λa2b, λa3) emitted from the face 13a of the wavelength modification element 13, the fundamental wave light (λa3), whose wavelength has not been converted, enters the face 15b of the dichroic mirror 15 and passes through the dichroic mirror 15 to be emitted from the face 15a of the dichroic mirror 15, whereby the emitted light enters the optical radiation face 12a of the semiconductor laser element 12 and is amplified again inside the semiconductor laser element 12 to be emitted therefrom.

In this way, when the fundamental wave light (λa) emitted from the semiconductor laser element 12 is repeatedly reflected and amplified between the semiconductor laser element 12 and the fundamental wave light reflecting element 14, a wavelength portion of the fundamental wave light (λa) is converted by the wavelength modification element 13. The wavelength modification light (λab and λa2b . . . ) is thus formed so that the light rays are outputted in series to the outside via the dichroic mirror 15 and the reflective mirror 16. And where this fundamental wave light is, for example, infrared light having wavelength of 1064 nm, the wavelength modification light, which is outputted to the outside, turns into green visible light having wavelength of 532 nm. In addition, for example, where the light is infrared light having wavelength of 976 nm, the wavelength modification light, which is outputted to the outside, turns into blue visible light having wavelength of 488 nm. Moreover, for example, when the light is infrared light having wavelength of 930 nm, the wavelength modification light outputted to the outside turns into blue visible light having wavelength of 465 nm.

According to the above laser ray wavelength modification apparatus, since the selective reflection member 17, which reflects wavelength modification light, is provided, the wavelength modification light does not pass through the fundamental wave light reflecting element 14. Rather, it is outputted to the outside via the dichroic mirror 15, whereby the high light extraction efficiency is acquired.

### EMBODIMENTS

Although detailed description of embodiments according to the above will be given below, the described is not limited thereto.

### Embodiment 1

According to the structure shown in FIG. 1, a laser ray wavelength modification apparatus (1) was made under the conditions set forth below.

Semiconductor laser element (12) is an array having a semiconductor laser element structure, which emitted infrared light having wavelength of 1064 nm, as a fundamental wave light (λa), arranged on a substrate (11).

Wavelength conversion element (13) is a Periodically Poled Lithium Niobate (PPLN).

Fundamental wave light reflecting element (14) is a volume Bragg grating (VBG) having a thickness of 4 mm.

Selective reflection element (17) is a lamination body, which was a seventeen layer multilayer film, made up of silica (SiO2) layers and titania (TiO2) layers, formed by a vacuum deposition.

Dichroic mirror (15) (2.4 μm in thickness) with a face (15b) is arranged to be inclined by 45 degrees with respect to an optical axis L.

Reflective mirror (16) with a reflective face (16a) is arranged to be particular to the face (15b) of the dichroic mirror (15).

In addition, this laser ray wavelength modification apparatus (1) outputted green visible light having wavelength of 532 nm as wavelength modification light.

### Embodiment 2

A laser ray wavelength modification apparatus (2) was made with the same structure as that of the Embodiment 1, except that an oscillation wavelength of the semiconductor laser element (12) was 930 nm of infrared light, and the periodical structure, a reflection ratio, etc. were adjusted so that other components were compatible having that wave length. In addition, this laser ray wavelength modification apparatus (2) outputted blue visible light with a wavelength of 465 nm as wavelength modification light.

### Comparative Example 1

A laser ray wavelength modification apparatus (3) was similarly made with the same structure as that of Embodiment 1, except a selective reflection member (17) was not provided. In addition, this laser ray wavelength modification apparatus (3) outputted green visible light having wavelength of 532 nm as wavelength modification light.

### Comparative Example 2

A laser ray wavelength modification apparatus (4) was similarly made with the same structure as that of Embodiment 2, except a selective reflection member (17) was not provided. In addition, this laser ray wavelength modification apparatus (4) outputted blue visible light having wavelength of 465 nm as wavelength modification light.

### Assessment

By using the Laser ray wavelength modification apparatuses (1)-(4), the output increase rate of the Embodiment 1 was obtained on the basis of the Comparative Example 1 and the output increase rate of the Embodiment 2 was obtained on the basis of the Comparative Example 2. A result is shown in Table 1.

TABLE 1

| | | Output increase |
|---|---|---|
| | Apparatus | rate (%) |
| Embodiment 1 | 1 | 138 |
| Embodiment 2 | 2 | 116 |

The preceding description has been presented only to illustrate and describe exemplary embodiments of the present laser ray wavelength modification apparatus. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A laser ray wavelength modification apparatus, comprising:
a semiconductor laser element that emits a laser ray as a fundamental wave light;
a fundamental wave light reflecting element comprising a volume Bragg grating (VBG) that operates as an external resonator with respect to the semiconductor laser element;
a wavelength modification element arranged between the semiconductor laser element and the fundamental wave light reflecting element, the wavelength modification element converts a wavelength portion of the fundamental wave light to a wavelength modification light;
a selective reflection member that transmits and directs the fundamental wave light to the fundamental wave light reflecting element and that reflects the wavelength modification light from among emission of the wavelength modification element; and
a dichroic mirror arranged between the semiconductor laser element and the wavelength modification element, the dichroic mirror transmits the fundamental wave light and reflects the wavelength modification light.

2. The laser ray wavelength modification apparatus according to claim 1, wherein the wavelength modification element comprises a Periodically Poled Lithium Niobate (PPLN).

3. The laser ray wavelength modification apparatus according to claim 2, wherein the dichroic mirror inclines with respect to an optical axis of the fundamental wave light reflecting element.
